(19) United States
(12) Patent Application Publication
(10) Pub. No.: US 2024/0376926 A1
(43) Pub. Date: Nov. 14, 2024

(54) END NUT ASSEMBLY WITH EXTENDED SPACER

(71) Applicant: Applied System Technologies, Inc., Charlotte, NC (US)

(72) Inventor: Roman Todd Zarins, Denver, NC (US)

(21) Appl. No.: 18/782,133

(22) Filed: Jul. 24, 2024

Related U.S. Application Data
(63) Continuation-in-part of application No. 17/870,772, filed on Jul. 21, 2022.

(51) Int. Cl. F16B 37/04

(52) U.S. Cl. CPC F16B 37/04

(57) ABSTRACT

An end nut assembly may include a nut body defining a first portion and a second portion. A first opening is adjacent the first portion and a second opening is adjacent the second portion. An axial bore extends between the first opening and the second opening. An end nut assembly may also include a bite ring defining an outer ring and a plurality of teeth extending radially inwardly from the outer ring. An end nut assembly may further include a spacer defining an inner surface and an outer surface. The inner surface defines a cavity centrally located within the spacer. The spacer defines a first spacer portion with a first thickness and a second spacer portion with a second thickness that is less than the first thickness. The second spacer portion extends into a threaded portion of the nut body.

### CROSS-REFERENCE TO RELATED APPLICATIONS

This application is a continuation-in-part of U.S. patent application Ser. No. 17/870,772, filed on Jul. 21, 2022, entitled END NUT ASSEMBLY, the contents of which are incorporated in full by reference herein.

### TECHNOLOGICAL FIELD

The present disclosure relates generally to an end nut assembly, and more generally relates to an end nut assembly that is quick to connect to a coupling and does not utilize an o-ring using an extended spacer.

### BACKGROUND OF THE DISCLOSURE

A compressed air piping system generally consists of a compressor and piping to carry the compressed air to its desired destination. The piping that carries the compressed air may be placed in a building, such as a plant, stadium, arena, manufacturing facility, hospital, or the like. The piping is not a single piece of pipe laid in a straight line. Instead, the piping is composed of various shapes and sizes of pipe for carrying or transporting the compressed air. Each pipe serves a particular function in carrying the compressed air. Segments of pipes need to be joined together or coupled.

In joining segments of pipe, the coupling couples an end of each pipe segment together without affecting the functionality of the piping. The coupling may assist in not only joining two segments of pipe together, but may also assist in changing the direction of the pipe, allowing the piping to bend along a hallway, corridor, or the like. The coupling may also contain an additional inlet or outlet for allowing a measuring instrument to be inserted into the compressed air flow for measuring a particular parameter of the flow, such as flow rate, pressure, temperature and the like. The additional outlet portion may allow the compressed air to be redirected. Likewise, the additional inlet portion may be utilized to introduce another stream of compressed air into the flow of the piping or to introduce an element or item into the stream of compressed air flowing through the piping, such as an additional gas or other component (ions, odor control, etc.).

A fitting can be utilized to expedite the connection between piping and the coupling quickly and efficiently. There is a need for a fitting, that is a quick-to-connect fitting, that can easily and readily engage a pipe segment to a coupling in an effective and efficient manner. The present disclosure discloses an end nut assembly that is a quick-to-connect fitting that does not utilize an o-ring.

### BRIEF SUMMARY OF THE DISCLOSURE

In various embodiments, an end nut assembly is provided. In some aspects, the techniques described herein relate to an end nut assembly, including: a nut body defining a first portion and a second portion, a first opening is adjacent the first portion and a second opening is adjacent the second portion, an axial bore extends between the first opening and the second opening; a bite ring defining an outer ring and a plurality of teeth extending radially inwardly from the outer ring; and a spacer defining an inner surface and an outer surface, wherein the inner surface defines a cavity centrally located within the spacer, wherein the spacer defines a first spacer portion with a first thickness and a second spacer portion with a second thickness that is less than the first thickness, wherein the second spacer portion extends into a threaded portion of the nut body.

In some aspects, the techniques described herein relate to an end nut assembly, wherein the cavity defines an aperture through the spacer, wherein the aperture has a consistent cross-sectional area through at least a portion of the first spacer portion and the second spacer portion.

In some aspects, the techniques described herein relate to an end nut assembly, wherein the threaded portion of the nut body includes internal threads adjacent the second opening.

In some aspects, the techniques described herein relate to an end nut assembly, wherein the nut body defines an internal groove within the axial bore, wherein the first spacer portion is received by the internal groove within the axial bore. \In some aspects, the techniques described herein relate to an end nut assembly, wherein the internal groove is adjacent to the threaded portion of the nut body.

In some aspects, the techniques described herein relate to an end nut assembly, wherein the nut body is structured to receive a ported coupling, wherein the ported coupling defines external threading and an opening, wherein the second spacer portion is positioned within the opening of the ported coupling upon attachment of the nut body to the ported coupling.

In some aspects, the techniques described herein relate to an end nut assembly, wherein the nut body further includes a shoulder disposed within the axial bore and adjacent to an internal groove within the axial bore.

In some aspects, the techniques described herein relate to an end nut assembly, wherein the spacer is positioned within the axial bore and contains a circular cross-section and at least one finger is disposed on the outer surface for engaging the nut body.

In some aspects, the techniques described herein relate to an end nut assembly, further including an identification ring containing an indicia marking portion, wherein the identification ring is received on a receiving surface on the second portion of the end nut assembly.

In some aspects, the techniques described herein relate to an end nut assembly, wherein the spacer is positioned within the axial bore and contains two or more resiliently, flexible fingers disposed on the outer surface for engaging the nut body.

In some aspects, the techniques described herein relate to a method of providing an end nut assembly, the method including: providing a nut body defining a first portion and a second portion, a first opening is adjacent the first portion and a second opening is adjacent the second portion, an axial bore extends between the first opening and the second opening; positioning a bite ring within the nut body, wherein the bite ring defines an outer ring and a plurality of teeth extending radially inwardly from the outer ring, and positioning a spacer within the nut body, wherein the spacer is positioned adjacent to the bite ring, wherein the spacer defines an inner surface and an outer surface, wherein the inner surface defines a cavity centrally located within the spacer, wherein the spacer defines a first spacer portion with a first thickness and a second spacer portion with a second thickness that is less than the first thickness, and wherein the second spacer portion extends into a threaded portion of the nut body.

In some aspects, the techniques described herein relate to a method, wherein the cavity defines an aperture through the spacer, wherein the aperture has a consistent cross-sectional area through at least a portion of the first spacer portion and the second spacer portion.

In some aspects, the techniques described herein relate to a method, wherein the threaded portion of the nut body includes internal threads adjacent the second opening.

In some aspects, the techniques described herein relate to a method, wherein the nut body defines an internal groove within the axial bore, wherein the first spacer portion is received by the internal groove within the axial bore.

In some aspects, the techniques described herein relate to a method, wherein the internal groove is adjacent to the threaded portion of the nut body.

In some aspects, the techniques described herein relate to a method, wherein the nut body is structured to receive a ported coupling, wherein the ported coupling defines external threading and an opening, wherein the second spacer portion is positioned within the opening of the ported coupling upon attachment of the nut body to the ported coupling.

In some aspects, the techniques described herein relate to a method, wherein the nut body further includes a shoulder disposed within the axial bore and adjacent to an internal groove within the axial bore.

In some aspects, the techniques described herein relate to a method, wherein the spacer is positioned within the axial bore and contains a circular cross-section and at least one finger is disposed on the outer surface for engaging the nut body.

In some aspects, the techniques described herein relate to a method, further including an identification ring containing an indicia marking portion, wherein the identification ring is received on a receiving surface on the second portion of the end nut assembly.

In some aspects, the techniques described herein relate to a method, wherein the spacer is positioned within the axial bore and contains two or more resiliently, flexible fingers disposed on the outer surface for engaging the nut body.

The aforementioned embodiments are but a few examples of configurations of the systems, apparatuses, and methods disclosed herein. Further understanding and a detailed coverage of the embodiments follows herein.

### BRIEF DESCRIPTION OF THE DRAWINGS

The present disclosure is illustrated and described herein with reference to the various drawings, in which like reference numbers denote like method steps and/or system components, respectively, and in which:

FIG. 1 is a front perspective view of the nut body, in accordance with various embodiments of the present disclosure;

FIG. 2 is a back perspective view of the nut body, in accordance with various embodiments of the present disclosure;

FIG. 3 is an exploded view of the end nut assembly, in accordance with various embodiments of the present disclosure;

FIG. 4 is a cut-away view of the nut body, in accordance with various embodiments of the present disclosure;

FIG. 5 is an exploded cut-away view of the end nut assembly, in accordance with various embodiments of the present disclosure;

FIG. 6 is a front perspective view of the bite ring, in accordance with various embodiments of the present disclosure;

FIG. 7 is a back perspective view of the bite ring, in accordance with various embodiments of the present disclosure;

FIG. 8A is a side view of the bite ring, in accordance with various embodiments of the present disclosure;

FIG. 8B is another side view of the bite ring, in accordance with various embodiments of the present disclosure;

FIG. 9 is a perspective view of the identification ring, in accordance with various embodiments of the present disclosure;

FIG. 10 is a side view of the identification ring, in accordance with various embodiments of the present disclosure;

FIG. 11 is a cut-away view of the identification ring, in accordance with various embodiments of the present disclosure;

FIG. 12 is a perspective view of the spacer, in accordance with various embodiments of the present disclosure;

FIG. 13 is a perspective view of the spacer, in accordance with various embodiments of the present disclosure;

FIG. 14 is a cut-away view of the spacer, in accordance with various embodiments of the present disclosure;

FIG. 15 is a perspective view of end nut assemblies engaged to a ported coupling, in accordance with various embodiments of the present disclosure;

FIG. 16 is an exploded view of end nut assemblies and a ported coupling, in accordance with various embodiments of the present disclosure;

FIG. 17 is a cut-away view of an end nut assembly and ported coupling, in accordance with various embodiments of the present disclosure; and

FIG. 18 is a cut-away view of end nut assemblies engaged to a ported coupling, in accordance with various embodiments of the present disclosure.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed invention(s). Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

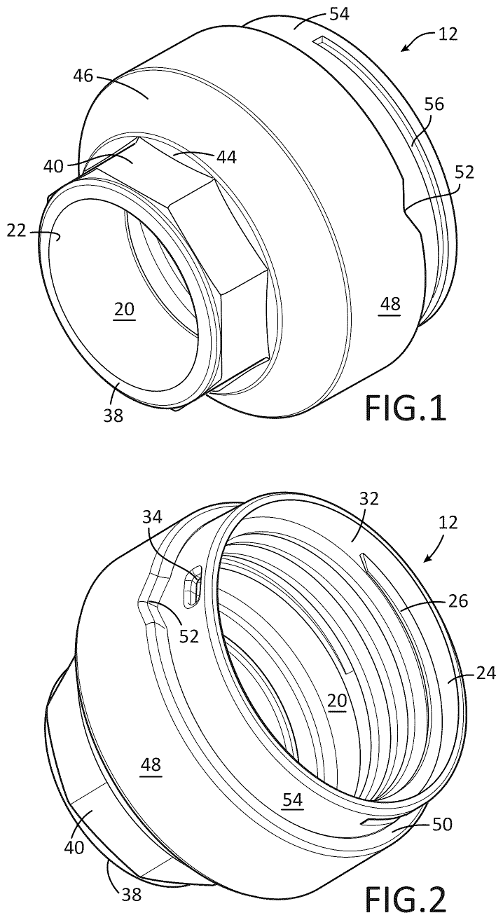

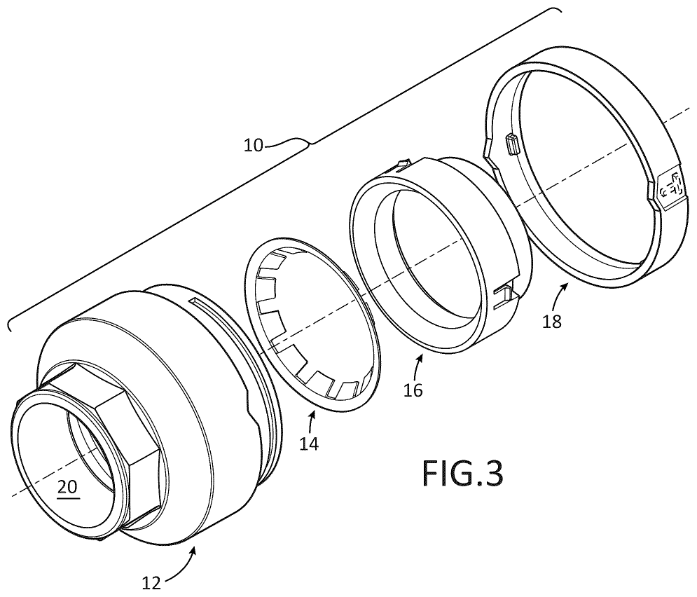

Referring now specifically to the drawings, an end nut assembly is illustrated in FIGS. 1-5 and is shown generally as reference numeral 10. The end nut assembly 10 is comprised of a nut body 12, a bite ring 14, a spacer 16, and an optional identification ring 18. The nut body 10 defines an axial bore 20 extending between a first portion and a second portion. A first opening 22 is adjacent the first portion and a second opening 24 is adjacent the second portion, wherein the axial bore 20 extends therebetween. The nut body 10 contains a conical inner surface forming the bounds of the axial bore 20 with an internally threaded portion with internal threads 26. The axial bore 20 proceeds a predetermined distance from the first opening 22 in the first portion and has a constant diameter with a smooth inner surface that is conical and without any rough portions, grooves, threads, or protrusions.

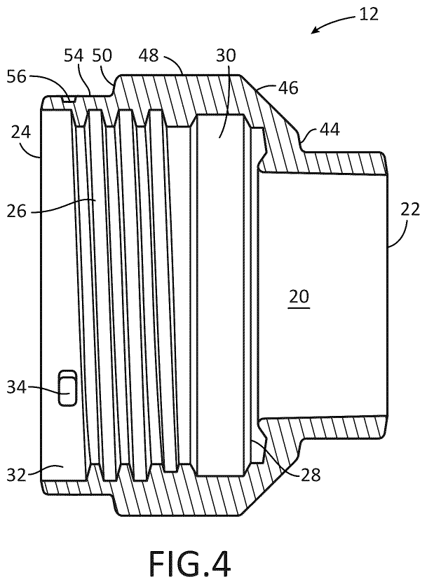

A shoulder 28, as illustrated in FIG. 4, is disposed within the axial bore 20 and positioned at a predetermined distance from the first opening 22 in the first portion, containing a constant diameter. The shoulder 28 is configured to receive the bite ring 14 and an internal groove 30 is disposed adjacent the shoulder 28 for receiving the spacer 16. The internal groove 30 may have an inside diameter greater than the inside diameter of the first opening 22. The internally threaded portion containing internal threads 26 is located adjacent the internal groove 30 and a second opening surface 32 is disposed adjacent the threaded portion and adjacent the second opening 24 in the second portion.

The second opening surface 32 is located on the second portion of the nut body 12 and adjacent the second opening 24. The second opening surface 32 partially forms the inner surface of the nut body 12 and contains a smooth surface that is conical and without any rough portions, grooves, threads, or protrusions. At least one second portion opening 34 is disposed on the second portion of the nut body 12. The second portion opening 34 extends from the exterior surface of the nut body 12 to the inner surface of the nut body 12.

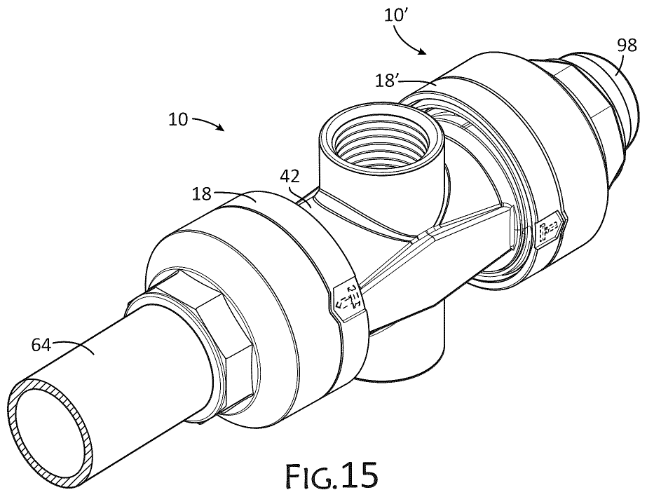

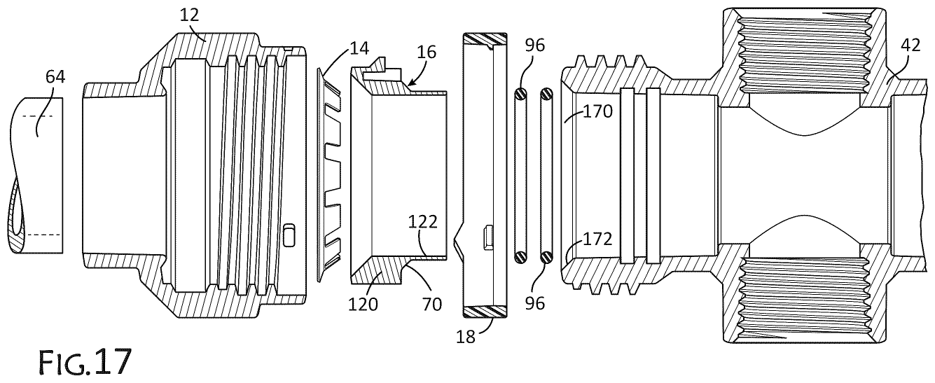

The first portion of the nut body 12 contains a circumferential lip 38 adjacent the first opening 22. A geometrically shaped outer portion, which is an octagonally shaped outer portion, as illustrated in the figures, is disposed adjacent the circumferential lip 38 containing a plurality of wrench flats 40. The wrench flats 40 are disposed about the outer periphery of the nut body 12 on the first portion, as shown in FIGS. 1-3. The wrench flats 40 are intended to receive a wrench or other similar tool for rotating the nut body 12. The nut body 12 may be attached to a coupling, such as a ported coupling 42 as illustrated in FIG. 15-18, or other device. The wrench or similar tool may engage the wrench flats 40 for rotating the nut body 12 for engagement to the ported coupling 42 or for disengaging or removing the nut body 12 from the ported coupling 42. The internal threads 26 of the nut body 12 threadedly connect to a coupling or other device. As shown in FIGS. 15-18 the internal threads 26 threadedly connect to exterior threads of the ported coupling 42. The nut body 12 may be threaded onto and unthreaded from the ported coupling 42.

A first shelf 44 is disposed adjacent the octagonally shaped outer portion, as shown in FIGS. 1 and 4. The first shelf 44 circumscribes the outer portion nut body 12. A chamfered portion 46 axially extends from the first shelf 44 to an outer ring surface 48 that is the outermost surface of the end nut assembly 10 and circumscribes the end nut assembly 10. The outer ring surface 48 extends from the chamfered portion 46 to an outer edge. The outer edge is adjacent a second shelf 50. The second shelf 50 circumscribes the end nut assembly 10 and contains at least one indent 52. The indent 52 consists of a first portion and a second portion, wherein the portion of the second shelf 50 between the first portion and the second portion extends within the outer ring surface 48 towards each other and meeting at a substantially midway point between the first portion and the second portion within the outer ring surface 48. The second shelf 50 may contain two or more indents 52 or a plurality of indents 52 spaced along the second shelf 50. A receiving surface is disposed adjacent the second shelf 50 and adjacent the second portion of the end nut assembly 10. As described above, at least second portion opening 34 is disposed within the receiving surface 54 extending from the exterior surface to the inner surface of the nut body 12. As illustrated, a second portion opening 34 may be disposed adjacent an indent 52 on the second shelf 50. The receiving surface 54 may contain two or more second portion openings 34 or a plurality of second portion openings 34.

A channel 56, as shown in FIG. 1, is disposed on the receiving surface 54. The channel 56 is preferably disposed in close proximity to the outer edge of the second portion of the nut body 12 adjacent the second opening 24. The channel 56 partially circumscribes the receiving surface 54 and does not fully circumscribe the receiving surface 54 or extend along the entire receiving surface 54. The channel 56 preferably has the same width between a first end and a second end of the channel 56, along with a constant channel depth.

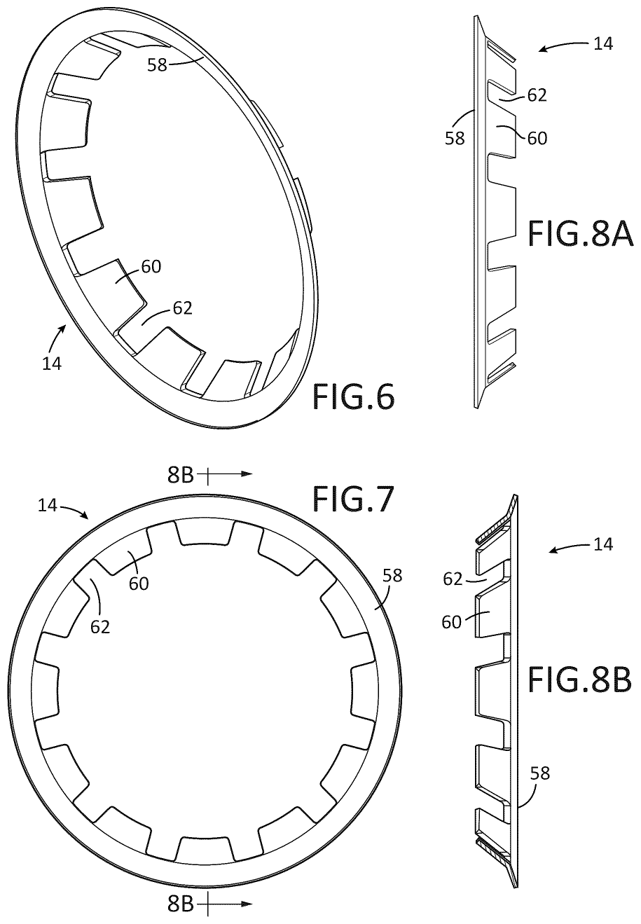

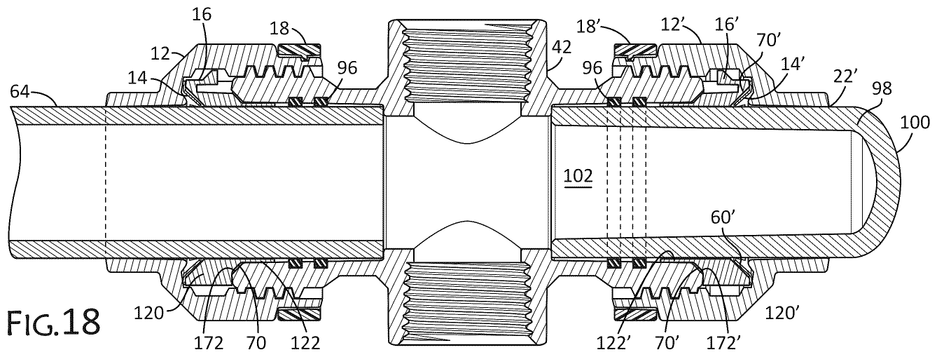

The bite ring 14, as illustrated in FIGS. 6, 7, 8A, and 8B can interface with the ported coupling 42 or other device to which the nut body 12 is engaged. The bite ring 14 contains an outer ring 58 and a plurality of teeth 60 extending radially inwardly from the outer ring 58. The teeth 60 contain two side portions extending radially inwardly from the inner surface of the outer ring 58, wherein the two side portions are disposed on either side of each tooth 60 and extend radially inwardly towards an outer edge. A void 62 is positioned between each tooth 60 along the inner surface of the outer ring 58. As illustrated, the teeth 60 are spaced an equal distance apart along the inner surface of the outer ring 58 and a void 62 is disposed between each tooth 60 along the inner surface of the outer ring 58. The teeth 60 may be flexible and/or bendable, and preferably at least bendable along the intersection with the inner surface of the outer ring 58. The teeth 60 may also be flexible and/or bendable in addition to being bendable along the intersection with the inner surface of the outer ring 58. The bite ring 14 is positionable within the axial bore 20 and can be seated on the shoulder 28, as shown in FIG. 18. The outer surface of the outer ring 58 is seated on the shoulder with the plurality of teeth 60 extending radially inwardly to the axial bore 20. The teeth 60 are designed to restrict translation of the portion of the pipe segment 64 relative to the axial bore 20 when the pipe segment 64 is moved within the axial bore 20.

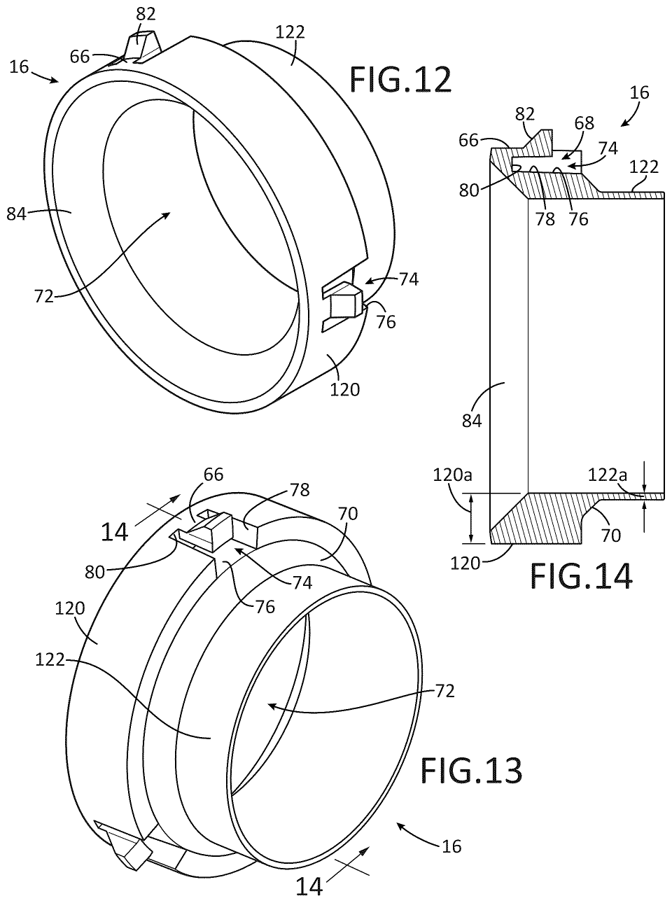

The spacer 16 is illustrated in FIGS. 12, 13, and 14. The spacer 16 is positioned within the axial bore 20 and received within the internal groove 30, as shown in FIG. 18. The spacer 16 contains a circular cross-section with an inner surface and an outer surface, wherein the inner surface defines a cavity 72 centrally located within the spacer 16. The spacer 16 contains an inner edge and an outer edge that form the openings for the cavity 72 and disposed on opposite sides of the spacer 16, extending from the inner surface to the outer surface. The transition between the outer edge and the inner surface is tapered and contains a tapered section 70, as shown in FIGS. 13 and 14. At least one finger 66 is disposed on the outer surface of the spacer 16. The finger 66 is preferably resiliently flexible containing a first end and a second end. The finger is contained or at least partially contained within a slot 74 disposed within the exterior surface of the spacer 16. The slot 74 is formed within the exterior surface of the spacer. The slot 74 contains a base portion 76, two-spaced apart side portions 78 disposed on opposite sides of the base portion 76, and an end portion 80. The portion of the slot 74 opposite the end portion is open and formed within the outer edge of the spacer 16. The first end of the finger 66 is engaged to the base portion 76 of the slot 74 in a cantilevered fashion and a space 68 is formed between the finger 66 and the base portion 76 of the slot 74. The finger 66 is spaced apart from the base portion 76, wherein the space 68 is disposed between the inner surface of the finger 66 and the base portion 76, as shown in FIG. 14.

The finger 66 extends from the end portion 80 of the slot 74, containing an inner surface, an outer surface, two spaced-apart side portions, and a top end portion. The two spaced-apart side portion and top end portion do not contact any surface of the slot 74 when the finger 66 is in the relaxed state, meaning the finger 66 is not contacting any other surface or surface of a device. The top end portion of the finger 66 is spaced-apart from the outer edge of the spacer 16, creating a distance between the top end portion of the finger 66 and the outer edge of the spacer 66. A protrusion 82 is disposed on the outer surface of the finger 66 and extends radially outwardly. The protrusion 82 extends outwardly from the outer surface of the finger 66 and extends beyond the outer diameter of the spacer 16. As illustrated in FIG. 14, the protrusion 82 may have a triangular cross-section. The finger 66 is resiliently flexible meaning the finger 66 may pivot or bend along the intersection with the end portion 80—of the slot 74 when pressure or force is applied to the finger 66. The finger 66 may pivot or bend inwardly until the inner surface of the finger 66 contacts the base portion 76 of the slot 74 when pressure or force is applied. Once the pressure or force is no longer applied to the finger 66, the finger 66 pivots or bends substantially back to its original position in the relaxed state prior to the pressure or force being applied, resulting in the inner surface of the finger 66 not contacting the base portion 76 of the slot 74 with a space 68 between the inner surface of the finger 66 and the base portion 76 of the slot 74. Alternatively, the finger 66 may pivot or bend radially outwardly from the slot 74 when pressure or force is applied. Once the pressure or force is no longer applied to the finger 66, the finger 66 pivots or bends substantially back to its original position in the relaxed state prior to the pressure or force being applied.

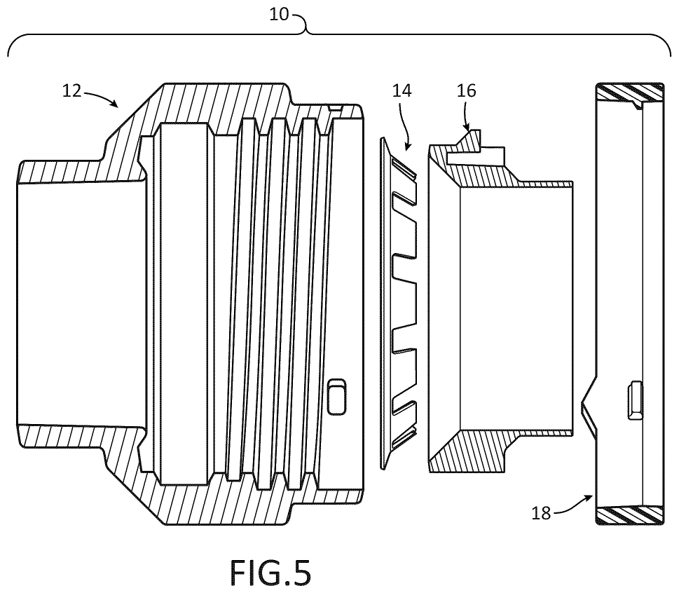

The transition between the inner edge of the spacer 16 and the inner surface is also tapered and contains a tapered section 84, as shown in FIGS. 12 and 14. The width of the tapered section 84 is greater than the width of the tapered section 70. As shown in FIGS. 5, 17, and 18, the exterior surface of the outer ring 58 of the bite ring 14 contacts the tapered section 84 when positioned within the axial bore 20 of the nut body 12. The teeth 60 may also contact the tapered section 84 and are received within the cavity 72. The spacer 16 is positioned within the axial bore 20 such that the protrusion 82 of the finger 66 is received within the second portion opening 34 within the receiving surface 54. The receiving surface 54 contains at least the same number of second portion openings 34 that correspond with the number of fingers 66 on the spacer 16 that is received within the axial bore 20 of the nut body 12. As illustrated in FIG. 13, the spacer 16 may contain three fingers 66 and three corresponding slots 74. However, the spacer 16 may contain one finger 66, two or more fingers 66, or a plurality of fingers 66. Likewise, the spacer 16 may contain one slot 74, two or more slots 74, or a plurality of slots 74.

In various embodiments, the spacer 16 defines a first spacer portion 120 and a second spacer portion 122 along the cavity 72. The first spacer portion 120 defines a first thickness 120A and the second spacer portion 122 defines a second thickness 120B. The first thickness is greater than the second thickness. The tapered section 70 is part of the transition between the first spacer portion and the second spacer portion. As shown in FIG. 18, the first spacer portion 120 is generally received by the internal groove 30 of the nut body 12 and the second spacer portion 122 extends into the opening 170 of the ported coupling 42. As such, the spacer 16 provides additional protection against leaks during operation. In various embodiments, the second spacer portion 122 of the spacer 16 allows for the end nut assembly to include less component, namely an o-ring is not required to provide a connection between the end nut assembly and the ported coupling 42.

In various embodiments, the cavity 72 defines an aperture through the spacer 16. In such an embodiment, the aperture may have a consistent cross-sectional area through at least a portion of the first spacer portion and the second spacer portion. For example, as shown in FIG. 14, the width of the aperture is consistent after the tapered section 84 and the exterior surface of the spacer 16 changes, causing the change in thickness between the first spacer portion 120 and the second spacer portion 122.

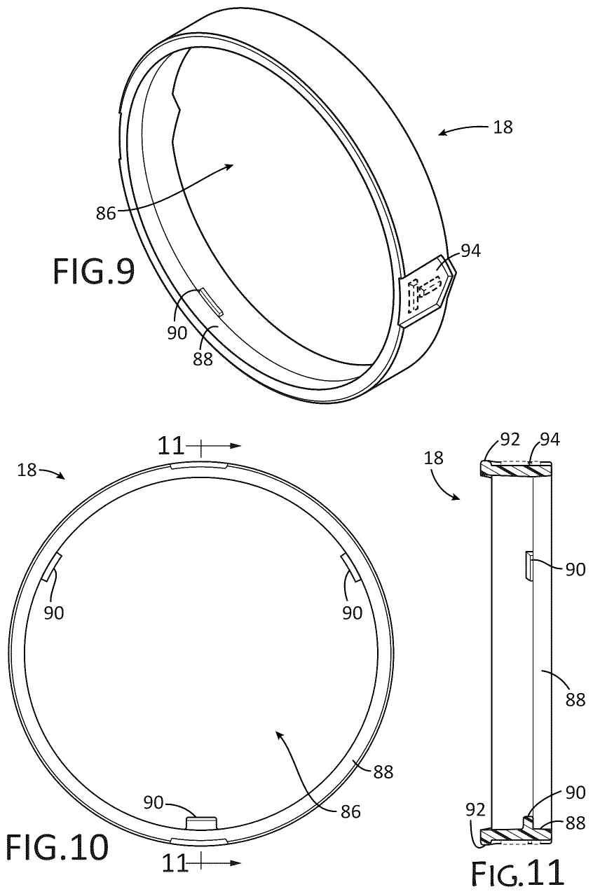

An identification ring 18 is illustrated in FIGS. 9, 10, and 11. The identification ring 18 is optional. The identification ring 18 has a circular cross-section with an inner surface, an outer surface, a first end, and a second end. A cavity 86 is formed within the inner surface and extends between the first end and the second end. The transition between the first end and the inner surface is tapered and contains a tapered section 88. At least one rib 90 extends radially inwardly from the inner surface of the identification ring 18. As illustrated in FIG. 10, three ribs 90 are disposed on the inner surface of the identification ring 18. Preferably, each rib 90 is spaced an equal distance apart from each other along the inner surface. The rib 90 is positioned on the inner surface adjacent the tapered section 88. The rib 90 is received within the channel 56 on the receiving surface 54. The outer surface of the identification ring 18 contains a lip 92 extending outwardly adjacent to the second end. The lip 92 extends continually around the outer surface of the identification ring 18, except for an optional indicia marking portion 94 than may be disposed on the outer surface of the identification ring 18. The indicia marking portion 94 is disposed within the outer surface of the identification ring 18 for receiving indicia markings, such as a logo, symbol, or words, that can identify the product or manufacturer. The indicia marking portion 94 is recessed within the outer surface of the identification ring 18. As illustrated in FIG. 9, the second end of the identification ring 18 contains an extended portion, which is a portion of the identification ring 18 that extends outwardly from the second end. As illustrated in FIG. 9, the indicia marking portion 94 is in the shape of a shield, but any other shape may be accommodated. The identification ring 18 may contain one or more indicia marking portions 94, two or more indicia marking portions 94, or a plurality of indicia marking portions 94. As shown in FIG. 15, the extended portion is received within the indent 52 on the exterior surface of the nut body 12.

As illustrated in FIGS. 15-18, the end nut assembly 10 may be attached to a coupling, such as a ported coupling 42 or other device. The ported coupling 42 contains external threads corresponding to the internal threads 26 within the nut body 12. As shown in FIGS. 15, 16, and 18, a first end nut assembly 10 is engaged to one end of the ported coupling 42 and a second end nut assembly 10′ is engaged to another end of the ported coupling 42.

The bite ring 14 and the spacer 16 are carried in the nut body 12. The bite ring 14 and the spacer 16 are positionable in the axial bore 20. The identification ring 18 is adjacent the receiving surface 54 of the nut body 12, surrounding the receiving surface 54 and adjacent the second shelf 50. The extended portion of the identification ring 18 is positioned within the indent 52, wherein the extended portion has a geometric configuration that corresponds with the geometric configuration of the indent 52, allowing the extended portion to be received within and positioned within the indent 52. The internal threads 26 of the nut body 12 threadedly connect to exterior threads of the ported coupling 42. The nut body 12 may be threaded onto and unthreaded from the ported coupling 42.

Upon threading the nut body 12 onto the ported coupling 42, the second spacer portion 122 of the spacer 16 extends into the opening 170 of the ported coupling 42. As such, the ported coupling 42 may define a tapered portion 172 of the opening 170. In an instance in which the nut body 12 is threaded onto the ported coupling 42, the tapered section 70 of the spacer 16 may be in contact with the tapered portion 172 of the opening 170, as shown in FIG. 18.

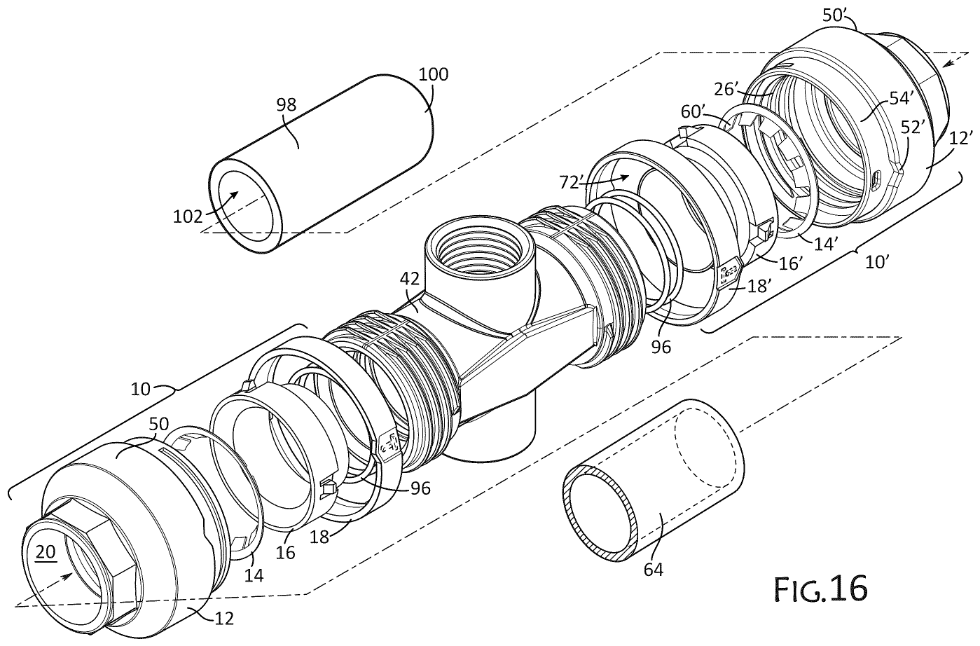

A pipe segment 64 may be inserted through the first opening 22 of the nut body 12 and into the axial bore 20. The pipe segment 64 progresses through the axial bore 20 where the pipe segment 64 passes through the cavity 72 in the spacer 16 and cavity 86 in the bite ring 14 and into an opening of the ported coupling 42. When the pipe segment 64 is inserted through the cavity 86 of the bite ring 14, the teeth 60 of the bite ring 14 engage the outer surface of the pipe segment 64 for retaining the pipe segment 64 within the nut body 12 of the end nut assembly 10. The tapered section 70 of the spacer 16 may also restrict radially outward movement of the teeth 60 from the outer ring 58, assisting with retaining the pipe segment 64 within the nut body 12 of the end nut assembly 10 without the need of o-rings. The teeth 60 when engaged to the outer surface of the pipe segment 64 can restrict translation of the pipe segment 64 relative to the axial bore 20. The inner surface of the spacer 16 contacts the exterior surface of the teeth 60 when a pipe segment 64 is inserted through the cavity 72 of the spacer 16 and the cavity of the bite ring 14, as illustrated in FIG. 18, preventing the pipe segment 64 from moving radially outward and creating an axial force that assist with engaging the teeth 60 to the outer surface of the pipe segment 64. O-rings 96, as pictured in FIGS. 16-18, may be used in the ported coupling 42, but are not used or contained by the end nut assembly 10. When the pipe segment 64 is inserted, the o-ring(s) 96 deform and engage the outer surface of the pipe segment 64, creating a fluid tight seal between the internal surface of the ported coupling 42 and the pipe segment 64.

As illustrated in FIGS. 15, 16 and 18, a second end nut assembly 10′ may be engaged to an opposed side of the ported coupling 42. The bite ring 14′ and the spacer 16′ are carried in the nut body 12′. The bite ring 14′ and the spacer 16′ are positionable in the axial bore 20′. The identification ring 18′ is adjacent the receiving surface 54′ of the nut body 12′, surrounding the receiving surface 54′ and adjacent the second shelf 50′. The extended portion of the identification ring 18′ is positioned within the indent 52′, wherein the extended portion has a geometric configuration that corresponds with the geometric configuration of the indent 52′, allowing the extended portion to be received within and positioned within the indent 52′. The internal threads 26′ of the nut body 12′ threadedly connect to exterior threads of the ported coupling 42. The nut body 12′ may be threaded onto and unthreaded from the ported coupling 42. A plug cap 98 may be inserted into an end nut assembly 10 instead of a pipe segment 64. As illustrated in FIGS. 15, 16 and 18, a plug cap 98 is inserted into the second end nut assembly 10′ to close the opening and prevent fluid, such as air, from flowing out of the opening when a pipe segment 64 is not inserted. The plug cap 98 is generally circular with a forward end and a rearward end. The forward end may contain a domed cap 100, while the rearward end contains an opening to a cavity 102. The plug cap 98 is hollow and contains a cavity 102 defined by the inner surfaces of the plug cap 98. The forward end is “closed,” while the rearward end is “open” and contains the opening and provides access to the central, hollow cavity 102 of the plug cap 98. The forward end may have a chamfered portion on the domed cap 100. The external surface of the plug cap 98 is smooth without any protrusions. Likewise, the internal surface of the plug cap 98 is smooth without any protrusions.

As illustrated in FIGS. 16 and 18, the rearward end of the plug cap 98 is inserted through the first opening 22′ of the nut body 12′ and into the axial bore 20′. The plug cap 98 progresses through the axial bore 20′ where the plug cap 98 passes through the cavity 72′ in the spacer 16′ and cavity in the bite ring 14′ and into an opening of the ported coupling 42′.

Upon threading the nut body 12′ onto the ported coupling 42, the second spacer portion 122′ of the spacer 16′ extends into the opening of the ported coupling 42. As such, the ported coupling 42 may define a tapered portion 172′ of the opening. In an instance in which the nut body 12′ is threaded onto the ported coupling 42, the tapered section 70′ of the spacer 16′ may be in contact with the tapered portion 172′ of the opening, as shown in FIG. 18.

When the plug cap 98 is inserted through the cavity of the bite ring 14′, the teeth 60′ of the bite ring 14′ engage the outer surface of the plug cap 98 for retaining the plug cap 98 within the nut body 12′ of the end nut assembly 10′. The tapered section 70′ of the spacer 16′ may also restrict radially outward movement of the teeth 60′ from the outer ring 58′, assisting with retaining the plug cap 98 within the nut body 12′ of the end nut assembly 10′ without the need of o-rings on the end nut assembly. The teeth 60 when engaged to the outer surface of the plug cap 98 can restrict translation of the plug cap 98 relative to the axial bore 20′. The inner surface of the spacer 16′ contacts the exterior surface of the teeth 60′ when a plug cap 98 is inserted through the cavity 72′ of the spacer 16′ and the cavity of the bite ring 14′, as illustrated in FIG. 18, preventing the plug cap 98 from moving radially outward and creating an axial force that assists with engaging the teeth 60′ to the outer surface of the plug cap 98. O-rings 96, as pictured in FIG. 18, may be used in the ported coupling 42, but are not used or contained by the end nut assembly 10, and utilized to retain the plug cap 98 within the ported coupling 42. When the plug cap 98 is inserted, the o-rings 96 deform and engage the outer surface of the plug cap 98, creating a fluid tight seal between the internal surface of the ported coupling 42 and the plug cap 98.

The nut body 12 is preferably composed of a metal, such as aluminum, but may be composed of any other material as desired by a user. The bite ring 14 and spacer 16 may by formed of a plastic, polymer material, or other suitable material as desired by the user.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure and are intended to be covered by the following claims.

What is claimed is:

1. An end nut assembly, comprising:
a nut body defining a first portion and a second portion, a first opening is adjacent the first portion and a second opening is adjacent the second portion, an axial bore extends between the first opening and the second opening;
a bite ring defining an outer ring and a plurality of teeth extending radially inwardly from the outer ring; and
a spacer defining an inner surface and an outer surface, wherein the inner surface defines a cavity centrally located within the spacer, wherein the spacer defines a first spacer portion with a first thickness and a second spacer portion with a second thickness that is less than the first thickness, wherein the second spacer portion extends into a threaded portion of the nut body.

2. The end nut assembly of claim 1, wherein the cavity defines an aperture through the spacer, wherein the aperture has a consistent cross-sectional area through at least a portion of the first spacer portion and the second spacer portion.

3. The end nut assembly of claim 1, wherein the threaded portion of the nut body comprises internal threads adjacent the second opening.

4. The end nut assembly of claim 1, wherein the nut body defines an internal groove within the axial bore, wherein the first spacer portion is received by the internal groove within the axial bore.

5. The end nut assembly of claim 4, wherein the internal groove is adjacent to the threaded portion of the nut body.

6. The end nut assembly of claim 1, wherein the nut body is structured to receive a ported coupling, wherein the ported coupling defines external threading and an opening, wherein the second spacer portion is positioned within the opening of the ported coupling upon attachment of the nut body to the ported coupling.

7. The end nut assembly of claim 1, wherein the nut body further comprises a shoulder disposed within the axial bore and adjacent to an internal groove within the axial bore.

8. The end nut assembly of claim 1, wherein the spacer is positioned within the axial bore and contains a circular cross-section and at least one finger is disposed on the outer surface for engaging the nut body.

9. The end nut assembly of claim 1, further comprising an identification ring containing an indicia marking portion, wherein the identification ring is received on a receiving surface on the second portion of the end nut assembly.

10. The end nut assembly of claim 1, wherein the spacer is positioned within the axial bore and contains two or more resiliently, flexible fingers disposed on the outer surface for engaging the nut body.

11. A method of providing an end nut assembly, the method comprising:
providing a nut body defining a first portion and a second portion, a first opening is adjacent the first portion and a second opening is adjacent the second portion, an axial bore extends between the first opening and the second opening;
positioning a bite ring within the nut body, wherein the bite ring defines an outer ring and a plurality of teeth extending radially inwardly from the outer ring, and
positioning a spacer within the nut body, wherein the spacer is positioned adjacent to the bite ring, wherein the spacer defines an inner surface and an outer surface, wherein the inner surface defines a cavity centrally located within the spacer, wherein the spacer defines a first spacer portion with a first thickness and a second spacer portion with a second thickness that is less than the first thickness, and wherein the second spacer portion extends into a threaded portion of the nut body.

12. The method of claim 11, wherein the cavity defines an aperture through the spacer, wherein the aperture has a consistent cross-sectional area through at least a portion of the first spacer portion and the second spacer portion.

13. The method of claim 11, wherein the threaded portion of the nut body comprises internal threads adjacent the second opening.

14. The method of claim 11, wherein the nut body defines an internal groove within the axial bore, wherein the first spacer portion is received by the internal groove within the axial bore.

15. The method of claim 14, wherein the internal groove is adjacent to the threaded portion of the nut body.

16. The method of claim 11, wherein the nut body is structured to receive a ported coupling, wherein the ported coupling defines external threading and an opening, wherein the second spacer portion is positioned within the opening of the ported coupling upon attachment of the nut body to the ported coupling.

17. The method of claim 11, wherein the nut body further comprises a shoulder disposed within the axial bore and adjacent to an internal groove within the axial bore.

18. The method of claim 11, wherein the spacer is positioned within the axial bore and contains a circular cross-section and at least one finger is disposed on the outer surface for engaging the nut body.

19. The method of claim 11, further comprising an identification ring containing an indicia marking portion, wherein the identification ring is received on a receiving surface on the second portion of the end nut assembly.

20. The method of claim 11, wherein the spacer is positioned within the axial bore and contains two or more resiliently, flexible fingers disposed on the outer surface for engaging the nut body.
